(19) United States
(12) Patent Application Publication
(10) Pub. No.: US 2025/0352427 A1
(43) Pub. Date: Nov. 20, 2025

(54) DOUBLE ENDED DILDO WITH REPLACEABLE ENDS

(71) Applicant: BANANA SPLIT, LLC, New York, NY (US)

(72) Inventors: Kathryn Adams Davis, New York, NY (US); Jabob Matthew Kuzrock, Los Angeles, CA (US); Angie Kim, Brooklyn, NY (US)

(21) Appl. No.: 19/196,601

(22) Filed: May 1, 2025

Related U.S. Application Data
(60) Provisional application No. 63/641,387, filed on May 1, 2024.

(51) Int. Cl. A61H 19/00

(52) U.S. Cl. CPC A61H 19/44; A61H 2205/087

(57) ABSTRACT

A dildo member having an end defining a ramp and an open region proximate the ramp. The ramp faces away from the open face and is tapered toward the open face. The open region is configured to receive a hook extending from a base end of a device separate from the dildo member. The hook has a distal end for engaging the ramp and for moving along the ramp when the dildo and/or the device are rotated with respect to each other, moving the dildo member and/or the device toward each other, releasably connecting the first dildo member and the device. A connector may be received in a cavity in the ends of the dildo member and in an end of another device, such as another dildo member or a cap, for example. A two ended dildo and a connector are also disclosed.

### RELATED APPLICATION

The present application claims the benefit of U.S. Provisional Patent Application No. 63/641,387, which was filed on May 1, 2024, is assigned to the assignee of the present invention, and is incorporated by reference herein.

### FIELD OF THE INVENTION

Dildos, and more particularly, dildo members with connectors enabling releasable connection to other dildo members and other devices.

### BACKGROUND OF THE INVENTION

Known commercially available double ended dildos have fixed shapes and orientations. The fixed nature of such products may prevent optimal pleasuring on one or more parties because the dildos shape may not work for both partners' bodies due to personal preferences and different-sized vaginal and anal canals, for example. Since double ended dildos are relatively niche products, commercial options are very limited and it is nearly impossible to get the fit right, especially for two or more parties.

### SUMMARY OF THE INVENTION

The ability to replace one or both ends of a dildo members with different dildo members having different shapes and/or sizes would be advantageous to users. The ability to change the orientation of curved dildos with respect to each other would also be advantageous to users. A dildo with two ends for use by partners or individuals in sexual activity. The ends are connected to the each other in a manner that allows for replacement of an end by another dildo chosen by a party.

In accordance with an embodiment of the invention, a dildo including two dildo members that are releasably connected to each other for use by partners or individuals in sexual activity is disclosed, where one or another dildo member may be replaced with another dildo member having a different size and/or shape, as desired by a party. A connector may be embedded in an end of each dildo, which may have the same shape as each other or different shapes. In this embodiment, dildos including the same connectors may be connected to each other. Curved dildos including the connectors may be connected to each other in a first orientation, with the dildos curved in the same direction, and in a second orientation, in which the dildos face in opposite directions, for example. The first and second orientations may be 180 degrees apart, for example. The connectors may be genderless/hermaphroditic connectors, so that dildo members may be freely connected to another. In one example, the connector is circular and cylindrical. The connector may have bi-radial symmetry. Each connector may include at least one hook and at least one opening to receive to receive a respective hook of another connector. In one example, each connector includes two opposing hooks and two openings. The dildo members may be made of 100% medical grade silicone, for example.

In accordance with an embodiment of the invention a dildo member is disclosed comprising a first stimulatory end and a second base end opposite the first, stimulatory end. The base end has an open face and defines a ramp and an open region proximate the ramp. The ramp faces away from the open face and is tapered toward the open face. The open region is configured to receive a hook extending from a base end of a device separate from the dildo member. The hook has a distal end for engaging the ramp and for moving along the ramp when the dildo and/or the device are rotated with respect to each other, moving the dildo member and/or the device toward each other, releasably connecting the first dildo member and the device to each other. The base may define a ledge having a surface facing away from the open face, and the ramp may be defined in the surface of the ledge facing away from the open face.

The device may comprise a second base end having a second open face. The base end may define a second ramp and a second open region proximate to the second ramp. The second may face away from the second open face and be tapered toward the second open face. The first dildo member may further comprise a hook extending from the base. The hook may be configured to be received in an opening defined by the open face of the device. The hook may have a distal end for engaging the second ramp and for moving along the second ramp when the dildo member and/or the device are rotated with respect to each other, moving the dildo member and/or the device toward each other.

The dildo member may further comprise a connector separate from the dildo member prior to assembly, which defines the ramp, the open region, and the hook. The connector may be received in a cavity defined in the base end and attached to the cavity during assembly. The device may comprise a second connector defining the ramp, the open region, and the hook of the second connector.

Two hooks may be provided on opposing sides of the connector and two hooks may be provided on opposing side of the second connector. A distal end of the hook of the connector and a distal end of a hook of the second connector may each comprise a protrusion for engaging the ramp of the second connector and the ramp of the connector, respectively, and for being moved along the respective ramp. The connector and the second connector may each further comprise a locking block positioned and configured with respect to the ramp of the connector and the ramp of the second connector to deflect the respective protrusion when the dildo member and the device are rotated with respect to each other. The locking block of the connector and a wall separated from the locking block may define a region on the ramp for receiving the protrusion of the hook of the second connector after passage of the protrusion past the locking block, to secure the protrusion in position. The locking block of the second connector and a wall separated from the locking block may define a region on the ramp for receiving the protrusion of the hook of the connector after passage of the protrusion past the locking block, to secure the protrusion in position.

The connector may further define a first slot and a second slot on an opposing side of the connector as the first slot. The first slot and the second slot having open ends facing in a direction of the open face, and the first and second slots are between the first hook and the second hook. A force applied to the base end of the dildo member, proximate the hooks, causes flexion of the connector, moving opposing walls of the slot towards each other and moving the protrusion at least partially away from the locking block, facilitating passage of the protrusion out of the region and past the locking lock, when the dildo member and/or the device are rotated with respect to each other to separate the dildo member and the device. Resilient material may be provided in the slot to provide a return force against the opposing walls of the slot when the opposing walls of the slot are moved toward each other. The closed end of the slots may have an radius to facilitate flexion of the connector.

The base end of the device may have an open face and the first dildo member may be releasably connectable to the device in a first orientation and in a second orientation rotated 180 degrees with respect to the first orientation. The open face of the dildo and the open face of the device may be bilaterally symmetric and an external surface of the first dildo member proximate the first open face and an external surface of the second open face of the device may be contoured so that when connected in the first orientation or in the second orientation, the contour of the first dildo member and the device at the connection is continuous.

The device may be a second dildo or a cap for closing the open face of the first dildo member, for example.

In accordance with another embodiment of the invention, a double ended dildo is disclosed comprising a first dildo member having a stimulatory end and a base end opposite the first, stimulatory end, the base end having a first open face defining a first cavity. A second dildo member has second open face defining a second cavity. A first connector is in the first cavity and a second connector in the second cavity. The first and second connectors each comprise a first and second ramp and a first and second open region proximate the first and second ramps, respectively. The first and second ramps face away from the open face of the first dildo member and the second dildo member, respectively, and the first and second ramps are tapered toward the open face of the first dildo member and the open face of the second dildo member, respectively. A first hook and a second hook extend from each of the first connector and the second connector. The first and second open regions of the first connector are each configured to receive the first and second hooks of the second connector, respectively, and the first and second open regions of the second connector are each configured to receive the first and second hooks of the first connector, respectively. The first and second hooks of the first connector each have a distal end for engaging the first and second ramps of the second connector and the first and second hooks of the second connector each have a distal end for engaging the first and second ramps of the first connector. The distal ends of the first and second hooks of the first and second connectors each move along a respective ramp when the first dildo member and the second dildo member are rotated with respect to each other, moving the first dildo member and/or the second dildo member toward each other, releasably connecting the first dildo member and the second dildo member.

In accordance with another embodiment of the invention, a connector is disclosed comprising a circular base having a first end and a second end. The circular base defines a first ramp and a second ramp opposite the first ramp, the first ramp and the second ramp each facing toward the second end and being tapered toward the first end. A first open region and a second open region are proximate the first and second ramps, respectively. A first hook and a second hook extend from the first end. The first open region and the second open region of the connector are each configured to receive a first hook and a second hook of a second connector. A first open region and a second open region of the second connector are each configured to receive the first hook and the second hook of the connector, respectively. The first hook and the second hook of the connector and the second connector each have a distal end for engaging a respective ramp of the connector and the second connector and to move along the respective ramp when the connector and/or the second connector are rotated with respect to each other, moving the connector and the second connector toward each other, releasably connecting the connector and the second connector. The connector and the second connector may each be connected to a first member and a second member, respectively, to releasably connect the first member and the second member to each other.

In accordance with embodiments of the invention, a dildo member may be releasably connected to another dildo member, a cap, or another device without an intermediate coupling member, although that is an option.

### BRIEF DESCRIPTION OF THE FIGURES

FIGS. 1A-1E are side views of examples of two ended dildos in different orientations, which may incorporate embodiments of the invention;

FIG. 2A is side view of an example of the two piece dildo 200, with the first and second dildo members separated, in accordance with an embodiment of the invention;

FIG. 2B is a perspective view of an example of connector embedded in a cavity in an open face of a dildo of FIG. 2A, in accordance with an embodiment of the invention;

FIG. 2C is a front view of the first end of a dildo member, showing the connector and protrusions extending outward from a center C of the connector, in accordance with an embodiment of the invention;

FIG. 3A is a side view of a connector used with the two piece dildo of FIG. 2A, in accordance with an embodiment of the invention;

FIG. 3B is a perspective view of the connector of FIG. 3A;

FIG. 3C is a bottom perspective view of the connector of FIG. 3A;

FIG. 3D is a bottom perspective view of the connector of FIG. 3A;

FIG. 3E is a partial side view of a portion of the inner wall of the connector of FIG. 3A, showing a ramp;

FIG. 4 is a partial breakaway view of an upper connector of a first dildo member (not shown) being lowered into a second connector of a second dildo member (not shown) during a connection process, in accordance with an embodiment of the invention;

FIGS. 5A-5D are various views of protrusions of a connector of a first dildo member during connection of the first dildo member to a second dildo member, in accordance with an embodiment of the invention;

FIG. 6A is a cross sectional view of a portion of an end of a dildo member, showing a connector received within a concave recessed region of a cavity, in accordance with an embodiment of the invention;

FIG. 6B is a partial cross sectional view of two connected dildo members, where the concave recessed region forms a compressed region between them, in accordance with an embodiment of the invention;

FIG. 7A is a side view of a connector including a slot in the connector wall, in accordance with an embodiment of the invention;

FIG. 7B is another side view of the connector of FIG. 7A, with an optional silicone pad provided in the slot, in accordance with an embodiment of the invention;

FIGS. 7C-7E are schematic representations of several steps of side views of a portion of an upper dildo member and the connector a lower dildo member in this view during separation of the upper and lower dildo members, in accordance with an embodiment of the invention;

FIG. 8A is a perspective view of a cap for closing an open face of a dildo member, including an optional suction cup bottom, in accordance with another embodiment of the invention;

FIG. 8B is a perspective view of a dildo member connected to the cap of FIG. 8A, secured to a surface, in accordance with an embodiment of the invention;

FIG. 8C is a top of a cap of FIG. 8A showing a connector received in a cavity in an open face of the cap, in accordance with an embodiment of the invention;

FIG. 9A is a schematic, cross sectional view of an example of a long dildo member in accordance with an embodiment of the invention, such as the long dildo in FIG. 1A; and

FIG. 9B is a schematic cross-sectional view of an example of a bulb dildo, such as the bulb dildo in FIG. 1A.

### DESCRIPTION OF EMBODIMENTS OF THE INVENTION

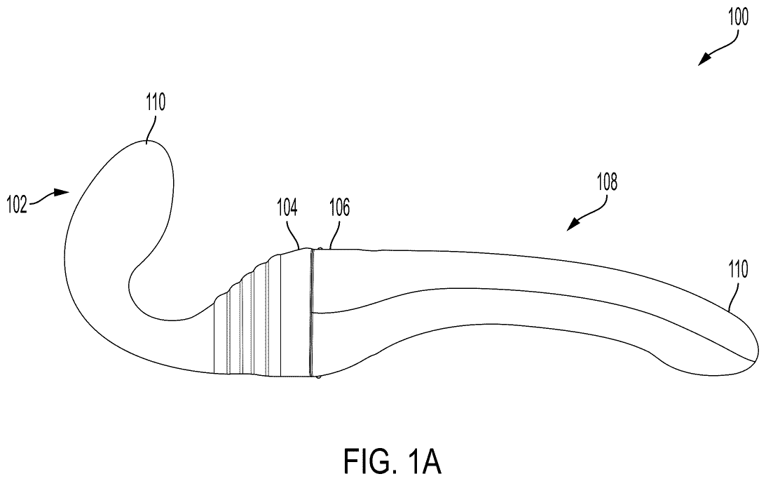

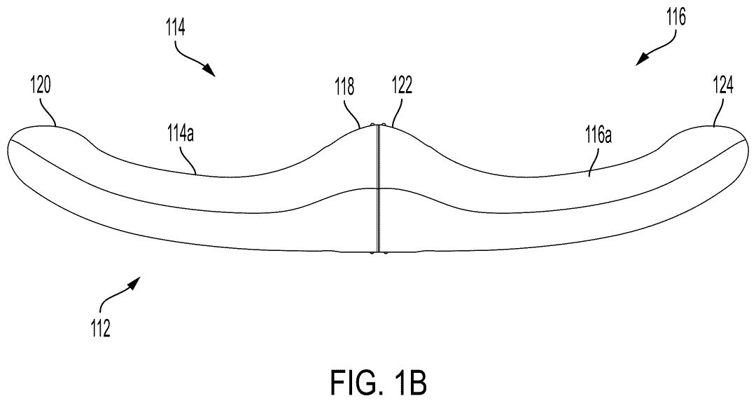

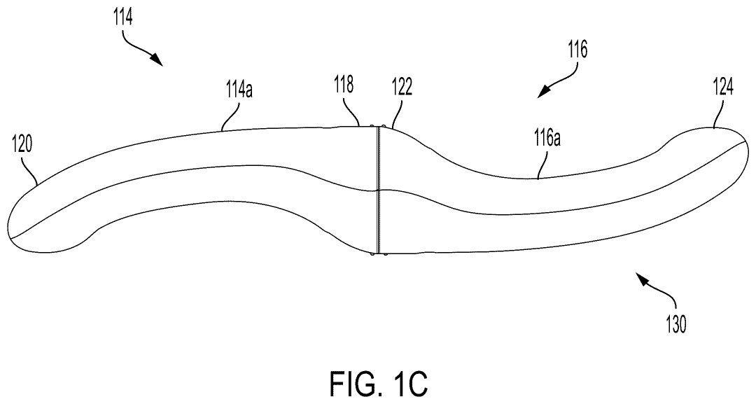

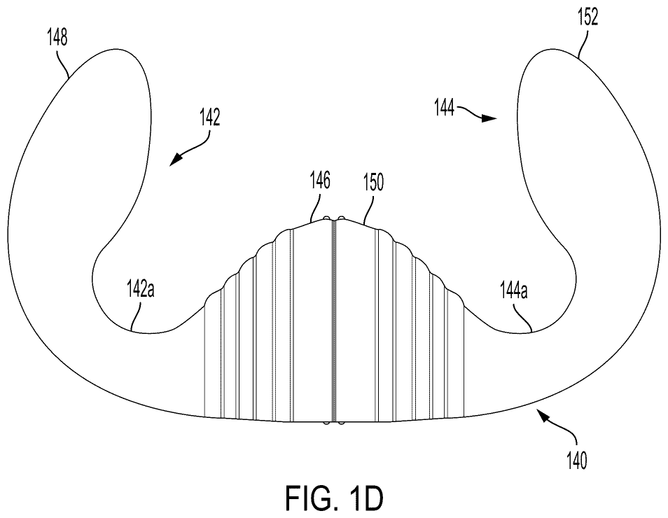

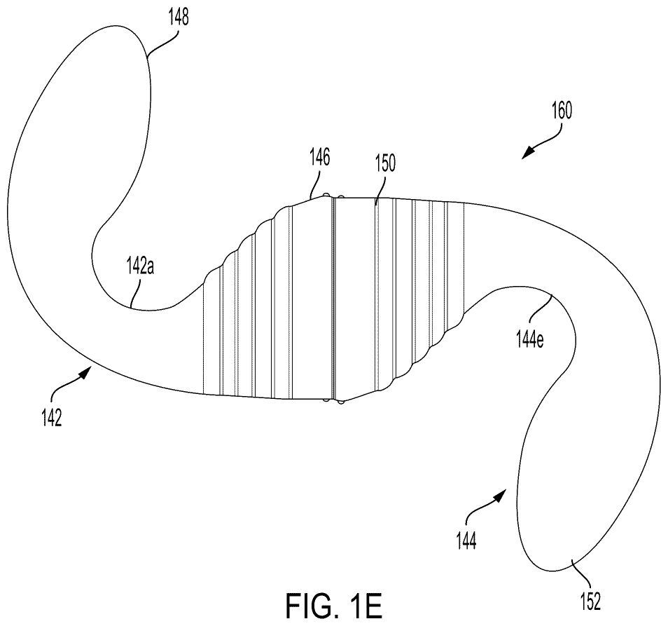

FIGS. 1A-1E are non-limiting examples of two ended dildos which may incorporate embodiments of the invention. FIG. 1A is a perspective view of an example of a two ended dildo 100 in which accordance with an embodiment of the invention. The two ended dildo 100 in this example includes a first, short dildo member 102, also referred to as a bulb, having a first end 104, which is a base end, and a second end 106, which is a stimulatory end. The second end 110 of the short bulb may be widened, as shown. The two ended dildo 100 also includes a second, long dildo member 108, which has a first end 106 and a second end 110. The first end 106 is a base end and the second end 110 is a stimulatory end. The first and second dildo members 102, 106 have curved bodies 102a, 106a between their first and second ends, respectively. The first end 104 of the first dildo member 102 is connected to the first end 108 of the second dildo member 106 so that the second end 110 of the first dildo member and the second end 110 of the second dildo member face in opposite directions, up and down in FIG. 1A, respectively. The long dildo member may have the appearance of a phallus. The long dildo member 106 may or may not look like an actual penis.

FIG. 1B is an example of a two ended dildo 112 in accordance with an embodiment of the invention, comprising two long dildo members, a first long dildo member 114 and a second long dildo member 116. The first long dildo member 114 has a first end 118 and a second end 120. The second long dildo member 116 has a first end 122 and a second end 124. The first and second dildo members 114, 116 have curved bodies 114a, 116a between their first and second ends, respectively. The first long dildo member 114 and the second long dildo member 116 are connected at their first ends 118, 122 so that the first ends 120, 124 face in the same direction, here up.

FIG. 1C is an example of a two ended dildo 130 in accordance with an embodiment of the invention, comprising the first long dildo member 114 and second long dildo member 116 of FIG. 1B, where the first ends 118, 122 of the first and second dildo members are connected so that the second ends 120, 124 face in opposite directions.

FIG. 1D is an example of a two ended dildo 140 in accordance with an embodiment of the invention comprising two short dildo members. In this example, a first short dildo member 142 has a first end 144 and a second end 146. A second short dildo member 148 has a first end 150 and a second end 152. The first and second dildo members 142, 144 have curved bodies 142a, 144a between their respective first and second ends. The first ends 146, 150 of the first and second short dildos 142, 144 are connected so that the second ends 148, 150 face in the same direction.

FIG. 1E is an example of a two ended dildo 160 in accordance with an embodiment of the invention, comprising the first short dildo member 142 and the second short dildo member of FIG. 1D, with their first ends 146, 150 connected so that the second ends 148, 152 face in opposite directions.

In accordance with embodiments of the invention, the dildo members of a two ended dildo may be separated and readily reattached in a different orientation, or one of the two dildo members may be replaced by another dildo member having a different size and/or shape. While the first and second dildo members in FIGS. 1A-1E are curved, one or both of the first and second dildos may be straight or have other shapes, for example.

When the first and second dildo members in the examples of FIGS. 1A-1E are connected to each other in either of the two orientations shown (both dildo members facing in the same direction or both dildo members facing in opposite directions), there is a continuous curve from the first dildo member to the second dildo member around the outer diameters of the first and second dildo members at their connection. To enable this, the surfaces where the two dildo members come together are bilaterally symmetric, such as a circle or an oval. Surfaces in the shape of circles having equal diameters may be connected at any orientation with a continuous curve from one dildo member to another. Surfaces in the shape of ovals having equal semi-major and semi-minor axes may be connected at orientations 180 degrees apart with a continuous curve from one dildo member to another. Other shapes may also be provided.

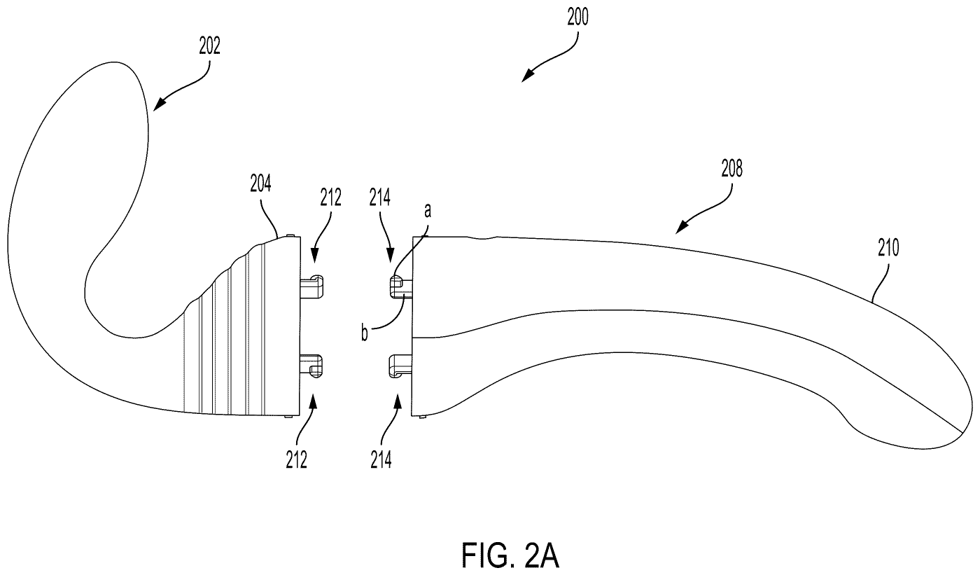

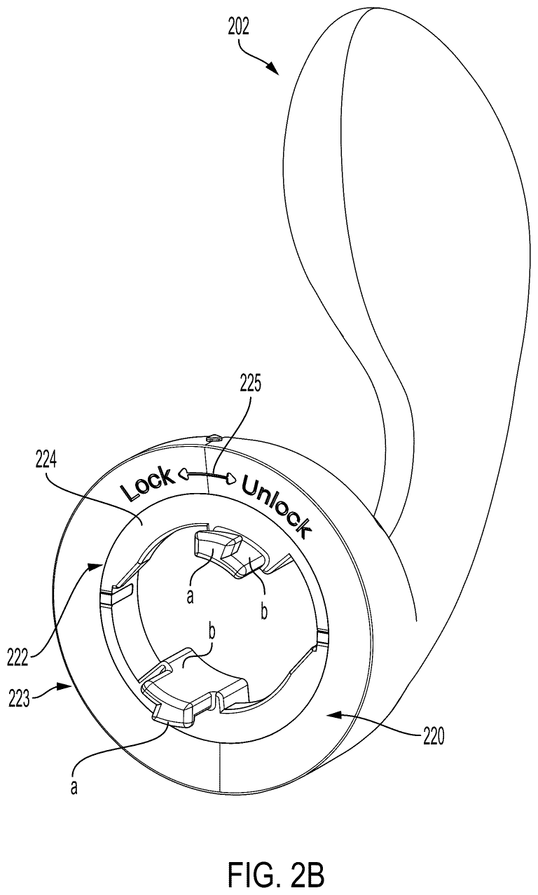

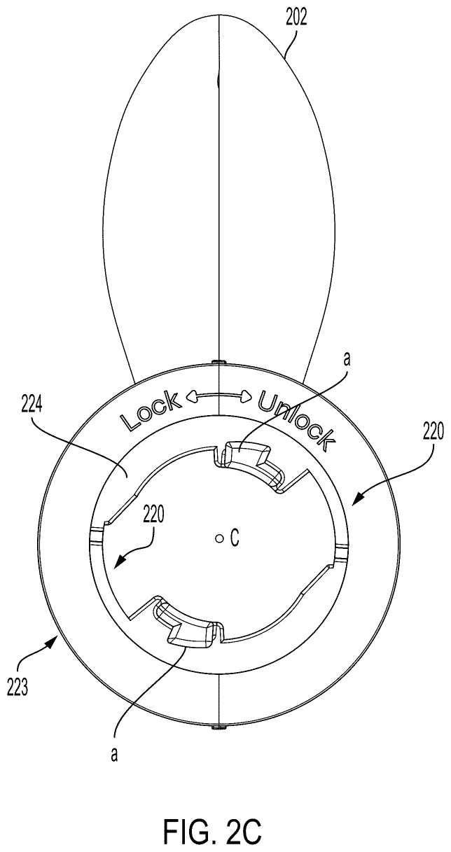

FIG. 2A is side view of an example of the two piece dildo 200 in accordance with an embodiment of the invention. The two ended dildo includes a first dildo member 202 having a first end 204, which is a base end, and a second end 206, which is a stimulatory end. The second end 206 in this example is widened. The two piece dildo 200 in this example further includes a second, long dildo member 208 having a first end 206, which is a base end, and a second end 210, which is a stimulatory end. The two piece dildo 200 of FIG. 2 corresponds to the two piece dildo 100 of FIG. 1, except that the first, short dildo member 202 faces downward and the second, long dildo member 208 faces upward.

The first and second dildo members 202, 208 are separated in FIG. 2A to show a first pair of engaging members 212 and a facing pair of engaging members 214 of the second dildo member 208. The engaging members 212, 214 in this example are hooks (which may also be referred to as lugs). Referring to the upper hook 214 in FIG. 2A, in this example, each hook includes a straight body portion “a” and a second, protruding portion “b” extending perpendicular to the body portion at its end. In this example, the protruding portion “b” extends toward an outer circumference of the first end 210 of the second dildo member 208. In other examples, the protruding portion b may face inward. In this example, the first pair 212 of hooks are part of a connector of the first dildo member 202 and the second pair of hooks 214 are part of a connector of the second dildo member 208 are part of the connector in the second dildo member 208, as described further below.

FIG. 2B is a perspective view of an example of connector 220 embedded in a cavity 222 in an open face 223 of the first dildo member 202 of FIG. 2A. The pair of hooks 212 are shown extending from the body 224 of the connector 220, which in this example is a circumferential ring. The bodies a and the protrusions b are also shown. The hooks 212 are in opposing positions around the connector 220. Optionally, an arrow 225 and instructions may be provided on the connector open face 223 of the dildo member 202 to indicate the directions to turn the dildo member 202 to “Lock,” and “Unlock” the dildo member with respect to another device, such as a second dildo member, for example.

FIG. 2C is a front view of the first end 204 of the first dildo member 202, showing the connector 222 and protrusions b extending outward from a center C of the connector. The connector has the shape of a circle and the first and second hooks are arranged along a diameter of the connector.

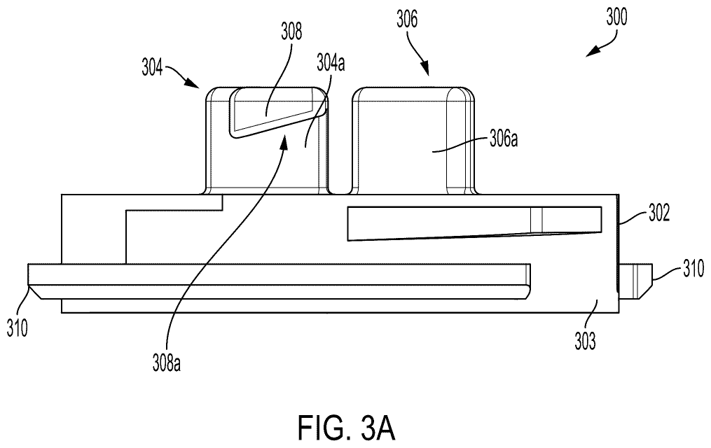

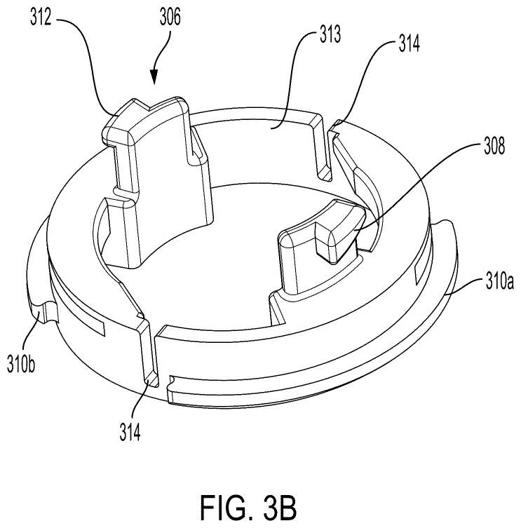

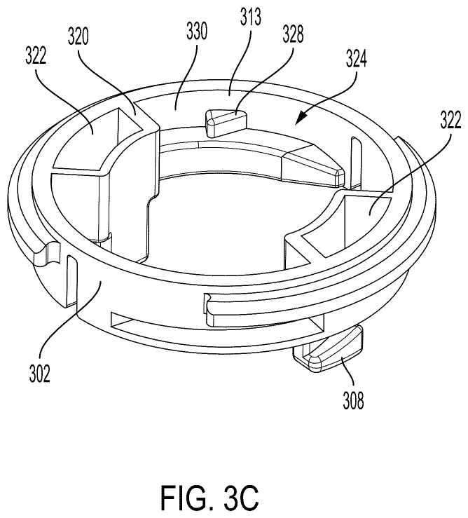

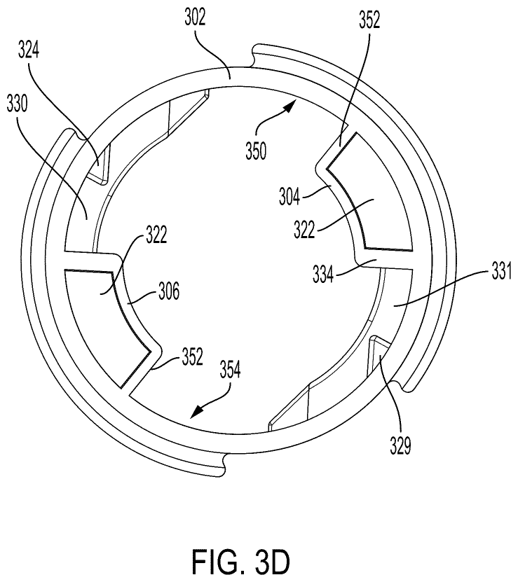

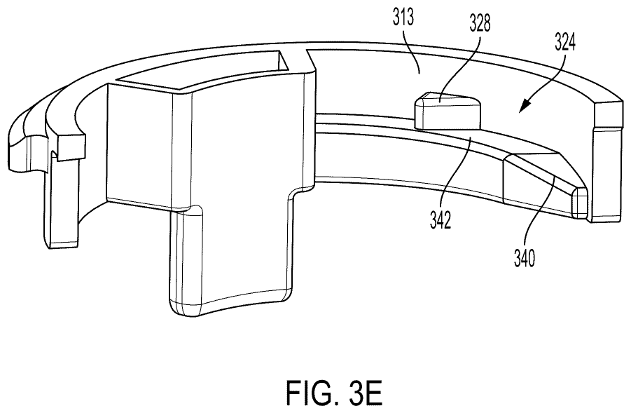

FIG. 3A is a side view of a connector 300 separate from a dildo member. The connector 300 comprises a circular body portion 302 including a wall 303 and two hooks 304, 306. The hook 304 is in the front portion the connector 300 and the hook 306 is in a rear portion of the connector in the view of FIG. 3A. The hook 304 has a body portion 304a and the hook 306 has a body portion 306a. A protrusion 308 is shown in the hook 304, while a protrusion on the hook 306 cannot be seen in this view. In this example, the protrusion 308 has a triangular shape with an angled surface 308a for engaging a ramp in the connector of the dildo member to which it is connected, as described further below. The protrusion 308 on the hook 306 may have a triangular shape. The protrusion 308 may have an angled surface 308a having an angle of about 25 degrees, for example. Partial circumferential ledges 310a, 310b extends outward from the wall 302, for engaging the cavity of a dildo member, as described further below. The first and second portions 310a, 310b of the ledge 310 each extend about 120 degrees around the connector 300, for example. One or more other partial circumferential ledges may also be provided to engage the cavity, as shown further below. The connecting members 300 may be made of a hard plastic, such as nylon. Nylon PA6 or nylon PA66 may be used, for example.

FIG. 3B is a perspective view of the connector 300 of FIG. 3A. A second protrusion 312 extending from the hook 306 is visible in this view, protruding towards the outer diameter of the connector 300. The inner and outer contours of the first and second hooks 304, 306 are each curved, following the curve of a first inner wall 313 of the wall 302. The first and second hooks 304, 306 are displaced radially inward from the first inner wall 313. Optional grooves or gaps 314 in the wall 302 are also shown in FIG. 3B, which facilitate the disengagement of connected connectors 300 in accordance with an embodiment of the invention, as discussed further below. Two opposing grooves 314 are provided in the example of FIG. 3B.

FIG. 3C is a bottom perspective view of the connector 300 of FIG. 3A. The bottom of the hooks 306, 308 defined, in part, by a second inner wall 320 protruding from the first inner wall 312. In this example, the second wall defines a hollow regions 322 in each hook 306, 308 to save plastic material and reduce weight of the connector 300. The hollow regions 322 may also receive glue and be placed on corresponding raised regions in a cavity in the open face of the respective dildo member. (See the open face 223 in FIG. 2B, for example.) The hollow regions 322 may also be overmolded with connecting features during manufacture

A first ramp 324 is also shown protruding from the first inner wall 312. A second ramp 326 is also provided opposite the first ramp 324, which is obscured by the wall 302 in this view but is shown in the bottom view of FIG. 3D. The first ramp 324 is tapered upward in this view, towards the hook 306. The second ramp 326 is also tapered upward, toward the hook 304. When positioned in the cavity of a dildo member, the tapering is toward the open face. A locking block 328 protrudes from the first inner wall 312 and the first ramp 326. In another example, the locking block 328 may protrude from only the first wall 312 or only from the first ramp 326. A locking region 330 is defined between the locking block 328 and a side of the second inner wall 320 of the hook 306 facing the locking block. The locking block 328 may be a triangular block, for example. The locking block 328 may have other shapes, as well. A locking block 329 is also provided and a locking region 331 is defined between the locking block 332 and a side wall 334 of the hook 304, as is also shown in FIG. 3D.

FIG. 3E is a side view of a portion of the inner wall 312 of the connector 300, showing the ramp 324. The ramp 324 in this example includes a first ramp portion 340 having a first angle of taper with respect to a horizontal line and a second ramp portion 342 having a second angle of taper. The first angle of taper in this example is steeper than the second angle of taper. In this example, the first angle of taper is about 20.5 degrees from a horizontal line and the second angle of taper is 2.50 degrees from a horizontal line.

Returning to FIG. 3D, a first open region 350 is defined between a sidewall 352 of the hook 304 and the ramp 328. A second open region 354, opposing the first open region 350, is defined between a sidewall 356 of the hook 306 and the ramp 326. The first and second open regions 350, 354 of one connector of one dildo member are configured to allow passage of respective hooks of a connector of a second dildo member to which it is being connected, and vice a versa.

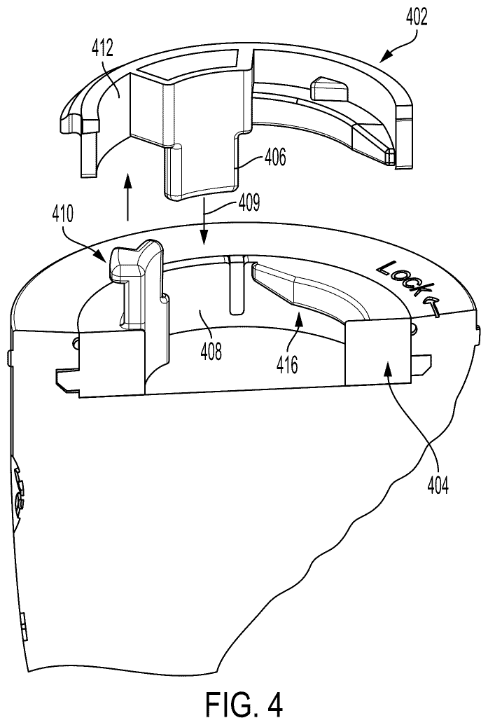

FIG. 4 is a partial breakaway view of an upper connector 402 of a first dildo member (not shown) being lowered into a second connector 404 of a second dildo member (not shown) during a connection process. In this view, the hook 406 of the upper connector 402 is moved towards the open region 408 of the lower connector 404, as indicated by the arrow 409, and the hook 410 of the lower connector 404 (only one of which is shown in this view) is shown approaching the open region 412 of the upper connector. When the protrusion (not shown) of the hook 406 of the upper connector 402 pass through the open region 408 of the lower connector 404, the protrusion is proximate the ramp 416 of the lower connector 404. The hook 410 of the lower connector 404 similarly approaches a position adjacent a ramp in the upper connector 402, which is not shown in this view. While FIG. 4 is described with respect to an upper connector 402 being moved down and into a lower connector 404, the lower connector 404 could be moved toward the upper connector 402, the upper and lower connectors may be moved toward each other simultaneously, or the dildo members may be arranged sideways so that one or both connectors are moved toward the other.

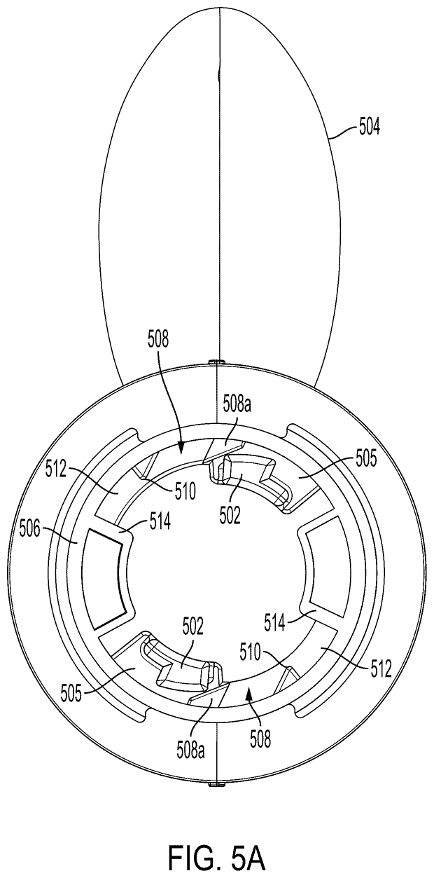

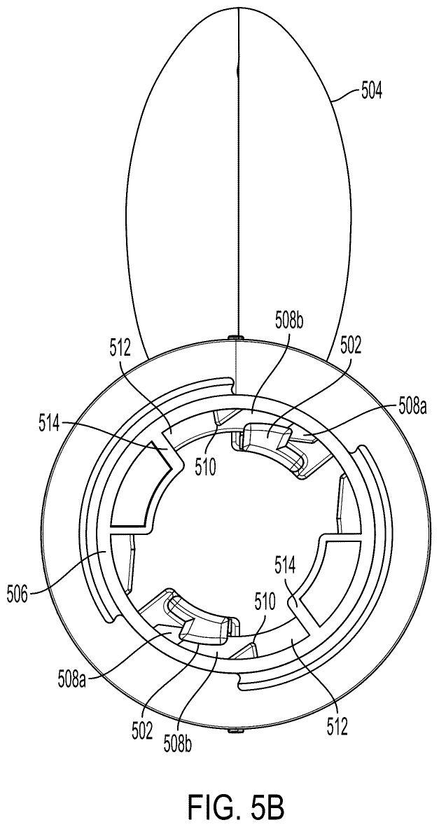

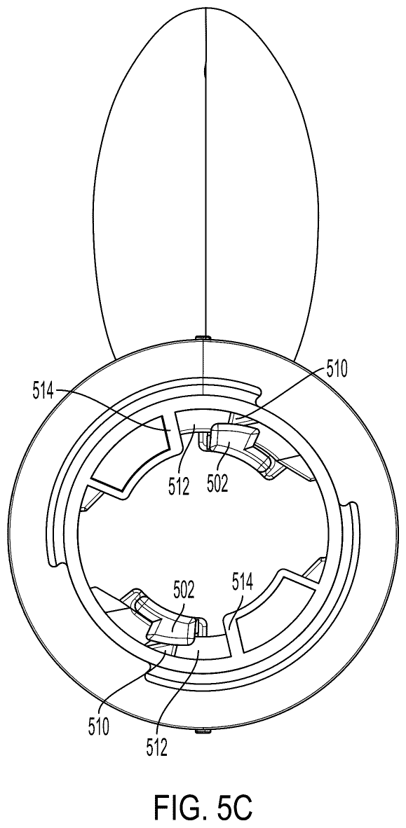

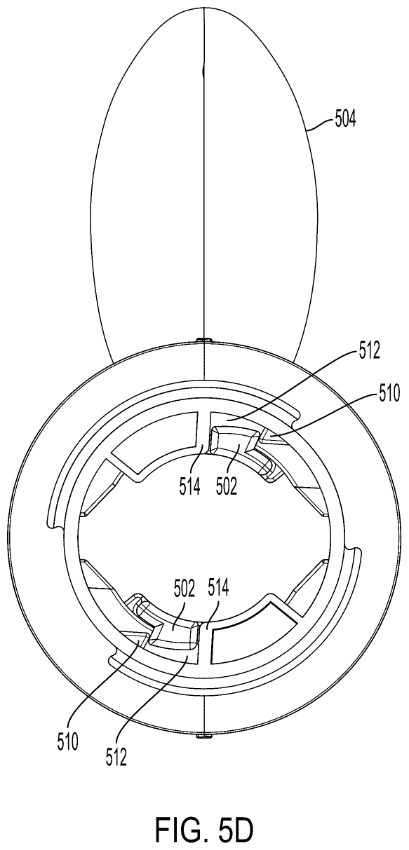

FIG. 5A is a front view of protrusions 502 of a connector connected to a first dildo member 504 which have passed through open regions 505 of a connector 506 of a second dildo member (not shown) during a connection process, in accordance with an embodiment of the invention. The hooks 502 are shown below and proximate the ramps 508 of the connector 506. Clockwise rotation of the second dildo member (not shown) causes the protrusions 502 to move into a locking position, as shown in FIGS. 5B-5D.

In FIG. 5A, the protrusions 502 are starting to engage the ramps 508. In particular, the angled surface 308a of the protrusions 502 (shown in FIG. 3A, for example) are starting to engage a first portion of the ramps 508a. As shown better in FIG. 3E, the ramp 340 in FIG. 3E (which corresponds to the first portion 508a of the ramp 508) is steeper than the remaining portion of the ramp 324, facilitating engagement of the protrusions with the ramp.

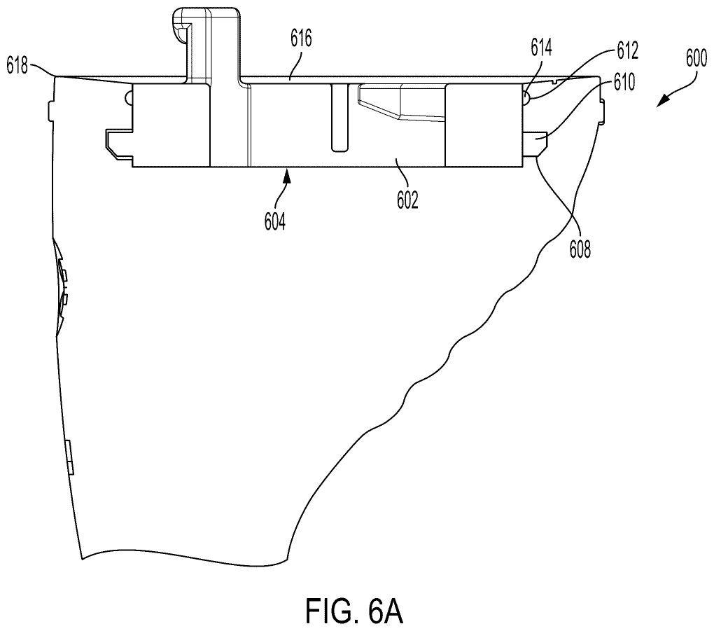

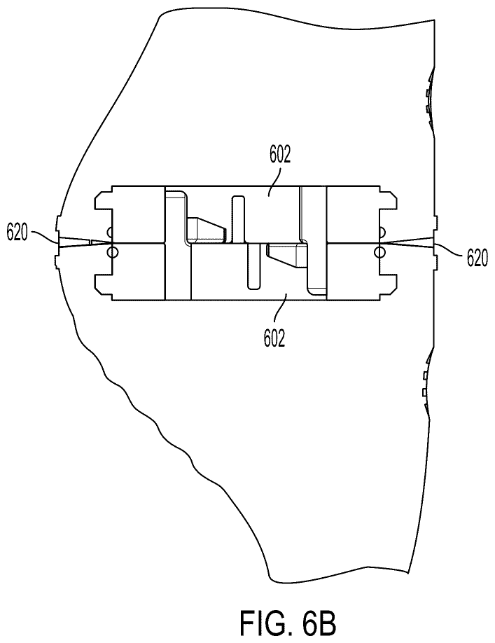

It is also noted that in accordance with this embodiment of the invention, due to the ramps 508 in FIG. 5A (as well as the ramps on the connector (not shown) of the first dildo member 504), the dildo members are brought closer together as one or both dildo members are rotated and the protrusions 502 (and protrusions of the second dildo member, which are not shown), ride up the ramps 508 and ramps of the first dildo member 504. In one example, the climb of the first ramp portion is about 1.5 mm and the climb of the second ramp portion is about 0.5 mm. The connectors, and therefore the dildo members, are therefore brought together by about 2.0 mm as the connectors are rotated. Bringing the dildo members close together enables formation of a seal between the two dildo members, as discussed further below with respect to FIGS. 6A and 6B.

FIG. 5B shows the protrusions 502 are moved from the first ramp portion 508a to the second ramp portion 508b, and toward the protrusion 510, after continued clockwise rotation of the second dildo member and the connector 506, by rotation of the second dildo member (not shown) in this example. The second ramp portion 508b, which corresponds to the second ramp 342 in FIG. 3E, is less steep than the first ramp portion 508a (340 in FIG. 3E). The protrusions 502 are moving toward a locking block 510 on the second ramp portion 508b (see locking block 328 in FIG. 3D).

In FIG. 5C, continued clockwise rotation of the first dildo member 504 results in the protrusions 502 moving further across the ramp 508b, into engagement with the locking block 510. As noted above, beyond the locking block are locking regions 512, between the locking blocks 510 and sidewalls 514 of the hooks 516. Engagement of the protrusions 502 with the locking block 510 deforms the protrusions, causing flexion of the straight body portion “a” of the hook away from the locking block, shown in FIG. 2A so that the protrusion 502 can pass the locking block 510 and move into the locking regions 512 upon further rotation of the first dildo member 504 in this example, as shown in FIG. 5D. When the protrusions 502 pass the locking blocks 510, the straight body portion “a” in FIG. 2A returns to its original position so the protrusions 502 sit between the locking blocs and the sidewalls 514, locking the connectors to each other. The protrusions 502 may snap into place in the locking regions 512. The fit of the protrusions 502 in the locking regions 512 may be a tight fit, for example. The protrusions 510 will stay in the locking region 512, connecting the dildo members to each other, until in FIG. 5D, the second dildo member 504 is moved counterclockwise, moving the protrusions out of the locking regions 512, over the locking blocks 510, and down the ramps 508, disengaging the dildo members from each other.

It should be understood that movement of the first dildo member 504 counterclockwise will similarly move the hooks 502 into engagement with the first ramp 508a, the second ramp 508b, past the protrusions 510, and into the locking region 512. Clockwise movement of the first dildo member 504 will also move the hooks 502 out of the locking regions, past the locking block, down the ramps 508b and 508a, into the open regions 505, allowing the dildo members to be separated. It is noted that both dildo members may be moved with respect to each other to connect and disconnect the dildo members.

After dildo members have been separated, a different dildo member having a different size and/or shape, for example, can be connected to one or the other dildo members, as desired by the users of the two ended dildos.

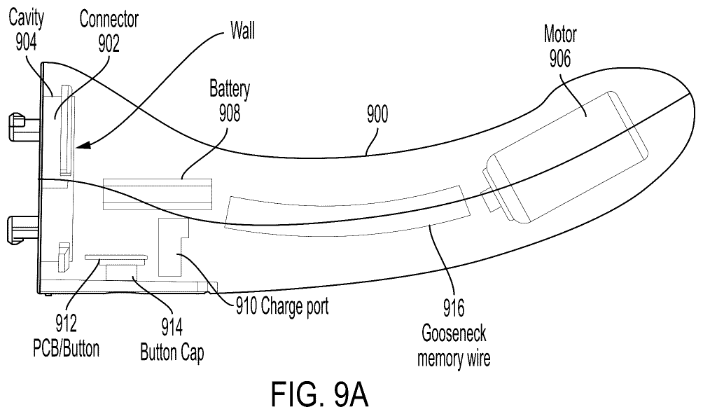

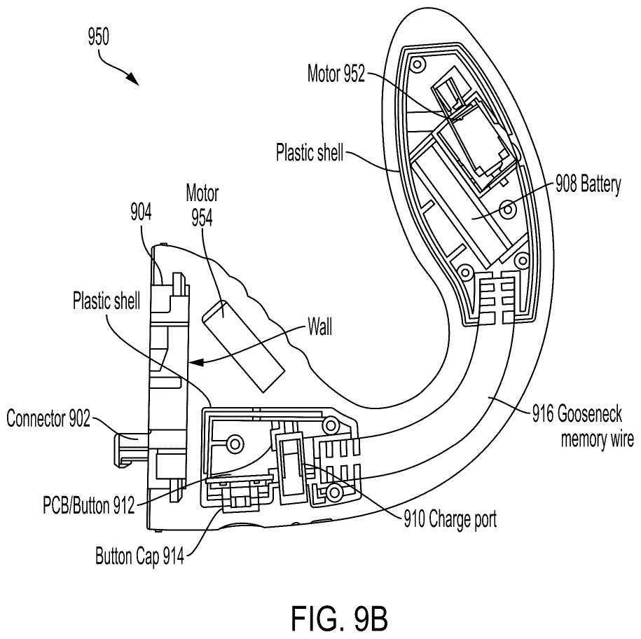

FIG. 6A is a cross sectional view of a portion 600 of an end of a dildo member, showing a connector 602 received within a cavity 604. The cavity 604 includes grooves 608 for receiving the ledges 610 of the connector 602 (see FIGS. 3A-3D for additional views of the ledges 610, where they are numbered 310a, 310b). Additional grooves 612, such as two or more additional grooves, may be provided to receive two or more additional ledges 614 near the top of the connector 602. Additional grooves and ledges may be provided. The connector 602 may be snap fit into the cavity 604. The connector 602 may also be connected to the cavity 604 by an adhesive, such as a glue, epoxy, or a silicone adhesive containing siloxane, for example instead of or along with the snap fit, to further secure the connector in position in the cavity 604. In another example, the connector 602 may be formed in the cavity by injection molding, for example. In this example, the bottom and sides of the cavity 604 are solid, separating the connector 602 from internal components of a dildo member, if any, as shown in FIGS. 9A and 9B, for example.

FIG. 6A also shows that in this example, the cavity 604 sits in a concave recessed region 616. The connector 602 is therefore slightly below the circumferential edge 618 of the dildo member 600. FIG. 6B is a partial cross sectional view of two connected dildo members, both of which include a concave recessed region 616. When attached, the connectors 602 are brought together, as discussed above, causing compression of the concave recessed regions 616 of both dildos against each other. FIG. 6B shows a compression region 620 where the concave recessed regions 616 of both dildo members press against each other. As discussed above, the dildo members may be brought together by 2.0 mm due to the climb of the first and second ramps 340, 342 in FIG. 3E, for example. The compression region 630 may therefore be 2.0 mm, for example. The compression region 620 thereby provides a seal or partial seal between the two dildos, blocking or mitigating the passage of lubricant, bodily fluids, or other materials into the connectors 602, for example.

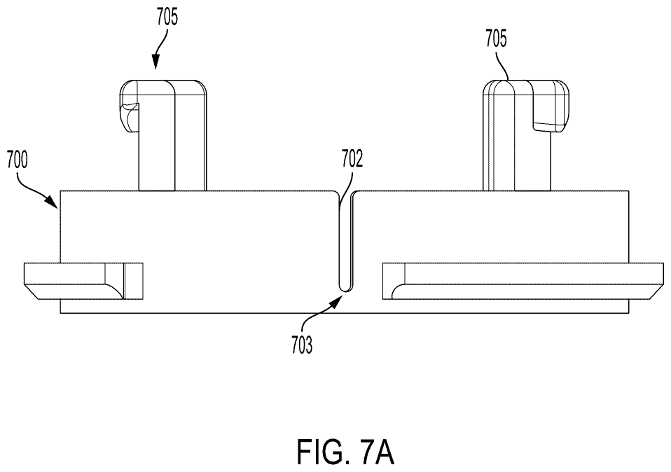

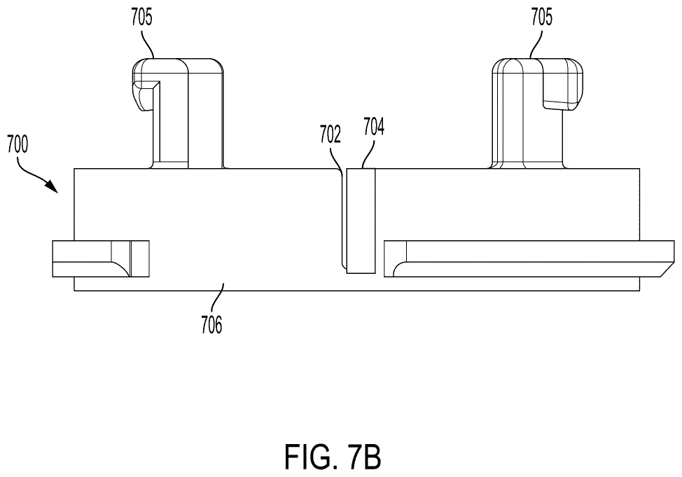

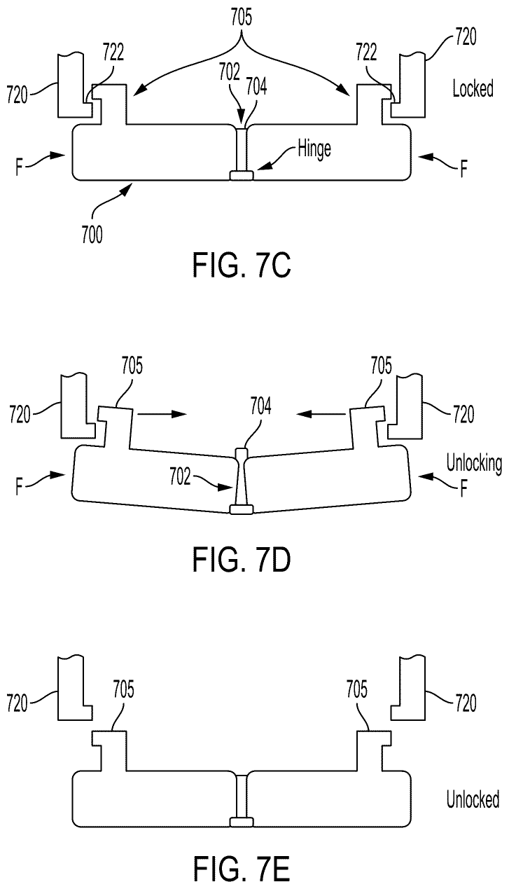

As discussed above with respect to FIG. 3B, optional slots or gaps 314 in the wall 302 of the connector 300 may be provided to facilitate the disengagement of connected connectors 300, in accordance with an embodiment of the invention. Two opposing slots 314 are provided in the example of FIG. 3B. FIG. 7A is a side view of a connector 700 including a slot 702. The second slot on the opposite side of the connector 700 is not shown in this view. In this example, the bottom corners 703 of each slot 702 may be curved to facilitate the flexion of the connector 700. The curves 703 may have a radius of 0.5 mm, for example. The curves 703 may also improve the durability of the connector 700. Other techniques may be used to facilitate the flexion of the connector 700, such as thinning the region of the connector below the slots 703, for example. Hooks 708 are also shown. The grooves 702 are provided between the locations of the hooks 705.

FIG. 7B is another side view of the connector 700, with an optional silicone pad 704 provided in the slot 702. Another silicone pad 704 may be provided in the other slot (not shown) on the opposite side of the connector 700. The silicone pads 704 provide a return force to the connector 700 after being flexed during disengagement. One slot 702 and silicone pad 704 are shown. As noted above, the other slot and silicone pad may be provided in the wall 706 opposite the location of the slot/silicone pad 702, 704. The radius 703 is not shown in FIG. 7B but may be provided.

FIGS. 7C-7E are side views of schematic representations of several steps in the separation of a connector 700 of a lower dildo member from a portion of an upper dildo member 720, in accordance with an embodiment of the invention. In FIG. 7C, the two hooks 705 extending from the connector 700 are shown in the locking regions of the ramps 722 of the portion 722 of the connector of a dildo member (not shown) above the connector 700. Two forces F are shown on opposite sides of the connector 700, proximate the hooks 705 and between the slots 702. In FIG. 7D, a forces F are shown causing flexion of the connector 700. The walls of the slot 702 are moved toward each other, compressing the silicone pad 704 and causing the connector 700 and the hooks to flex inward, as shown. The movement inward facilitates passage out of the locking regions 512 and past the locking blocks 510 shown in FIGS. 5A-5D, as one and/or the other dildo member is rotated. Dimples (not shown) may be provided in portions of wall of the dildo member to indicate where the forces F should be applied. After the hooks pass the locking blocks 510, the walls 710 may be released, although continued rotation of one or more of the connected dildos may be required to align the hooks with the open regions of the connector, allowing separation of the dildo members from each other, as shown in FIG. 7E. After the release of the force F on the wall of the dildo member, the silicone pad 704 provides a return force on the walls of the slots 702, opening the compressed slot 702 and causing the connector 700 to return to its unflexed position, as is also shown in FIG. 7E. Inward movement of the connector 700 also facilitates release of the hooks of the upper dildo member (not shown) from the locking region of the connector 700. The radius 703 is not shown in FIGS. 7C-7E but is indicated schematically by a rectangle referred to as a hinge in FIG. 7C.

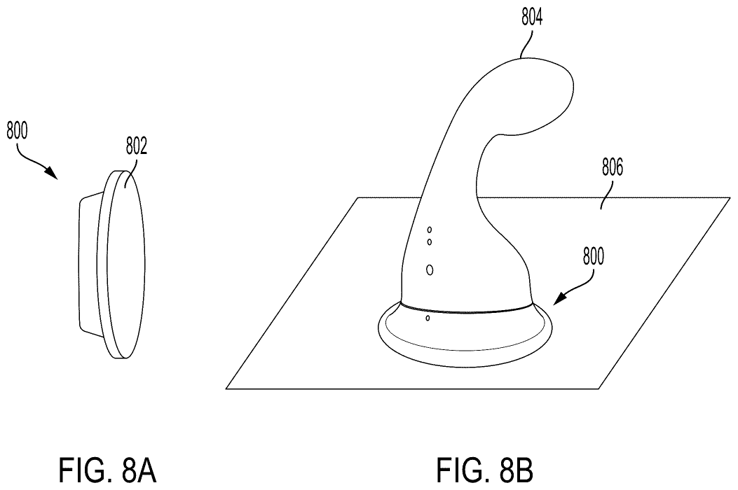

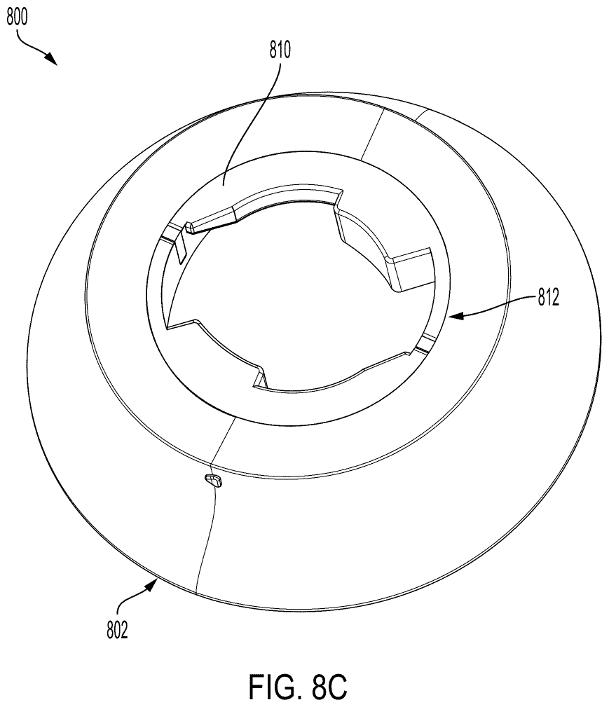

A dildo member, such as any of the dildo members in FIGS. 1A-1E, for example, that includes a connector in accordance with embodiments of the invention, may also be used as a single sided dildo. To protect the connector and other internal components of the dildo member, a cap containing a connector in accordance with any of the embodiments of the invention herein may be connected to the connector of the dildo member. FIG. 8A is a perspective view of a cap 800 including an optional suction cup bottom 802, in accordance with another embodiment of the invention. The suction cup bottom 802 may have a concave shape that will flatten when pressed against the solid surface 806, such as a table or shelf, enabling the dildo member 804 to be supported in an upright position on a surface 806, as shown in FIG. 8B. FIG. 8C is a top of a cap 800 showing a connector 810 in accordance with embodiments of the invention, received within a cavity 812 in an open face 814 of the cap, as described herein. The cap 800 may be made of the same material as the dildo member or other appropriate materials known in the art. The cap 800 may be made of silicone, for example.

FIG. 9A is a schematic, cross sectional view of an example of a long dildo member 900 in accordance with an embodiment of the invention, such as the long dildo member 06 in FIG. 1A. A connector 902 sitting in a cavity 904 are shown. The sides of the cavity 904 may be solid, as discussed above. The dildo member 900 may be a vibratory dildo member, but that is not required. A vibratory dildo may include a motor 906, to cause vibratory motion. A battery 908 is provided to provide power to the motor 906. If the battery is chargeable, a charge port 910 is provided through the wall of the dildo member. A button 914 for activation of the motor is provided through the wall of the dildo member. A wire or other electrical connection (not shown) may be provided from the button 914 to turn the motor 906 on and off. A button cap 916 may be provided over the button 914. An internal memory gooseneck wire 916 enables the dildo member 900 to maintain a configuration when bent. The gooseneck wire 916 may be made of steel or aluminum, for example. The body of the dildo member 900 may be a soft medical grade silicone, for example, which may be molded over the gooseneck wire 916.

FIG. 9B is a schematic cross-sectional view of an example of a bulb dildo member 950, such as the bulb dildo member 102 in FIG. 1A. Components common to FIG. 9A are commonly numbered. In accordance with an embodiment of the invention, two motors 952, 954 may be provided selectively causing vibratory stimulation in one and/or two different locations when the bulb is positioned by a user. For example, one motor, such as the motor 954, may cause internal stimulation and the motor 952 may cause external stimulation. The other components of the bulb dildo member 950 are the same as in FIG. 9A but may be in different locations.

Examples of implementations of embodiments of the invention are described above. Modifications may be made to these examples without departing from the spirit and the scope of the invention, which is defined by the claims, below.

What is claimed is:

1. A dildo member comprising a first stimulatory end and a second base end opposite the first, stimulatory end;
the base end having an open face, the base end defining a ramp and an open region proximate the ramp,
the ramp facing away from the open face and being tapered toward the open face, and
the open region being configured to receive a hook extending from a base end of a device separate from the dildo member, the hook having a distal end for engaging the ramp and to move along the ramp when the dildo and/or the device are rotated with respect to each other, moving the dildo member and/or the device toward each other, releasably connecting the first dildo member and the device to each other.

2. The dildo member of claim 1, wherein the base defines a ledge having a surface facing away from the open face, and
the ramp is defined in the surface of the ledge facing away from the open face.

3. The dildo member of claim 1, wherein the device comprises a second base end having a second open face, the second base end defining a second ramp and a second open region proximate to the second ramp, the second ramp facing away from the second open face and being tapered toward the second open face, and
the first dildo member further comprising a hook extending from the base, the hook being configured to be received in an opening defined by the open face of the device, the hook having a distal end for engaging the second ramp and moving along the second ramp when the dildo member and/or the device are rotated with respect to each other, moving the dildo member and/or the device toward each other.

4. The dildo member of claim 3, further comprising:
a connector separate from the dildo member prior to assembly, the connector defining the ramp, the open region, and the hook, the connector being a received in a cavity defined in the base end and attached to the cavity during assembly; and
the device comprises a second connector defining the ramp, the open region, and the hook of the second connector.

5. The dildo member of claim 4, wherein:
the connector comprises two hooks on opposing sides; and
the second connector comprises two hooks on opposing sides.

6. The dildo member of claim 4, wherein a distal end of the hook of the connector and a distal end of a hook of the second connector each comprises a protrusion for engaging the ramp of the second connector and the ramp of the connector, respectively, and for being moved along the respective ramp.

7. The dildo member of claim 6, wherein the connector and the second connector each further comprise a locking block positioned and configured with respect to the ramp of the connector and the ramp of the second connector to deflect the respective protrusion when the dildo member and the device are rotated with respect to each other.

8. The dildo member of claim 7, wherein:
the locking block of the connector and a wall separated from the locking block define a region on the ramp for receiving the protrusion of the hook of the second connector after passage of the protrusion past the locking block, to secure the protrusion in position; and
the locking block of the second connector and a wall separated from the locking block define a region on the ramp for receiving the protrusion of the hook of the connector after passage of the protrusion past the locking block, to secure the protrusion in position.

9. The dildo member of claim 5, wherein the connector further defines a first slot and a second slot on an opposing side of the connector as the first slot, the first slot and the second slot having open ends facing in a direction of the open face, and the first and second slots being between the first hook and the second hook,
wherein a force applied to the base end of the dildo member, proximate the hooks, causes flexion of the connector, moving opposing walls of the slot towards each other and moving the protrusion at least partially away from the locking block, facilitating passage of the protrusion out of the region and past the locking lock, when the dildo member and/or the device are rotated with respect to each other to separate the dildo member and the device.

10. The dildo member of claim 9, further comprising;
resilient material in the slot to provide a return force against the opposing walls of the slot when the opposing walls of the slot are moved toward each other.

11. The dildo member of claim 1, wherein:
the base end of the device has an open face;
the first dildo member is releasably connectable to the device in a first orientation and in a second orientation rotated 180 degrees with respect to the first orientation;
the open face of the dildo and the open face of the device are bilaterally symmetric; and
an external surface of the first dildo member proximate the first open face and an external surface of the second open face of the device are contoured so that when connected in the first orientation or in the second orientation, the contour of the first dildo member and the device at the connection is continuous.

12. The dildo of claim 1, wherein the device is a second dildo member.

13. The dildo member of claim 5, wherein the device is a cap for closing the open face of the first dildo member, the cap having a second cavity and a second connector received in the cavity, the second connector being the same as the first connector.

14. A double ended dildo comprising:
a first dildo member having a stimulatory end and a base end opposite the first, stimulatory end, the base end having a first open face defining a first cavity;
a second dildo member having a second open face defining a second cavity; and
a first connector in the first cavity and a second connector in the second cavity;
the first and second connectors each comprising:
a first and second ramp and a first and second open region proximate the first and second ramps, respectively, the first and second ramps facing away from the open face of the first dildo member and the second dildo member, respectively, the first and second ramps being tapered toward the open face of the first dildo member and the open face of the second dildo member, respectively, and
a first hook and a second hook extending from each of the first connector and the second connector;
wherein:
the first and second open regions of the first connector are each configured to receive the first and second hooks of the second connector, respectively,
the first and second open regions of the second connector are each configured to receive the first and second hooks of the first connector, respectively, and
the first and second hooks of the first connector each have a distal end for engaging the first and second ramps of the second connector;
the first and second hooks of the second connector each have a distal end for engaging the first and second ramps of the first connector;
the distal ends of the first and second hooks of the first and second connectors each moving along a respective ramp when the first dildo member and the second dildo member are rotated with respect to each other, moving the first dildo member and/or the second dildo member toward each other, releasably connecting the first dildo member and the second dildo member.

15. The double ended dildo of claim 14, wherein a distal end of each of the first and second hooks comprise a respective protrusion for engaging the each of the first and second ramps of the first and second connectors, respectively, and for being moved along each of the respective first and second ramps.

16. The double ended dildo of claim 14, wherein the first and second connectors each further define a first slot and a second slot on an opposing side of the respective connector as the first slot, the first slot and the second slot having open ends facing in a direction of the open face, and the first and second slots being between the first hook and the second hook, respectively,
wherein a force applied to the base end of either dildo member, proximate the hooks, causes flexion of the respective connector, moving opposing walls of the slot towards each other and moving the protrusions at least partially away from the respective locking block, facilitating passage of the protrusion out of the region and past the respective locking lock, when the first dildo and the device are rotated with respect to each other to separate the first dildo member and the second dildo member.

17. The dildo member of claim 16, further comprising;
resilient material in each of the first and second slots to provide a return force against the opposing walls of the respective slots when the opposing walls of the slots are moved toward each other.

18. The double ended dildo of claim 14, wherein:
the first cavity and the second cavity are recessed in the first open face and the second open face, respectively;
the first connector and the second connector are received in the first recessed cavity and the second recessed cavity, respectively; and
when the first dildo member and the second dildo member are releasably connected, the first open face and the second open face compress against each other.

19. A connector comprising:
a circular base having a first end and a second end, the circular base defining:
a first ramp and a second ramp opposite the first ramp, the first ramp and the second ramp each facing toward the second end and being tapered toward the first end;
a first open region and a second open region proximate the first and second ramps, respectively;
a first hook and a second hook extending from the first end;
wherein:
the first open region and the second open region of the connector are each configured to receive a first hook and a second hook of a second connector;
a first open region and a second open region of the second connector are each configured to receive the first hook and the second hook of the connector, respectively; and
the first hook and the second hook of the connector and the second connector each have a distal end for engaging a respective ramp of the connector and the second connector and to move along the respective ramp when the connector and/or the second connector are rotated with respect to each other, moving the connector and the second connector toward each other, releasably connecting the connector and the second connector.

20. The dildo member of claim 17, wherein the connector and the second connector are each connected to a first member and a second member, respectively, to releasably connect the first member and the second member to each other.
